(19) United States
(12) Patent Application Publication
(10) Pub. No.: US 2021/0026017 A1
(43) Pub. Date: Jan. 28, 2021

(54) APPARATUS FOR ASCERTAINING A DISTANCE TO AN OBJECT

(71) Applicant: Carl Zeiss AG, Oberkochen (DE)

(72) Inventors: Vladimir DAVYDENKO, Bad Herrenalb (DE); Frank HÖLLER, Aalen (DE); Andy ZOTT, Gerstetten (DE)

(21) Appl. No.: 17/010,723

(22) Filed: Sep. 2, 2020

Related U.S. Application Data
(63) Continuation of application No. PCT/EP2019/055498, filed on Mar. 6, 2019.

(30) Foreign Application Priority Data
Mar. 6, 2018 (DE) 10 2018 203 315.3
Oct. 26, 2018 (DE) 10 2018 126 754.1

(51) Int. Cl. G01S 17/89; G01S 17/26

(52) U.S. Cl. CPC G01S 17/89; G01S 17/26

(57) ABSTRACT

An apparatus for ascertaining a distance to an object has a light source that emits an optical signal having a time-varying frequency. An evaluation device ascertains a distance to the object based on a measurement signal that originated from the optical signal and was reflected at the object and, and on a reference signal that was not reflected at the object. A dispersive element produces a frequency-selective angle distribution of the measurement signal that has a plurality of partial signals which are steered to the object at mutually different angles.

### CROSS-REFERENCE TO RELATED APPLICATIONS

This application is a continuation application of International application No. PCT/EP2019/055498, filed Mar. 6, 2019, which claims priority to German patent application No. 10 2018 126 754.1, filed Oct. 26, 2018 and German patent application No. 10 2018 203 315.3, filed Mar. 6, 2018. Each of these applications is incorporated by reference herein in its entirety.

### BACKGROUND OF THE INVENTION

### Field of the Invention

The invention relates to an apparatus for ascertainment of a distance to an object. The apparatus can be used to ascertain distances to both moving and stationary objects and, in particular, to ascertain the topography or form of a spatially extended three-dimensional object when used in scanning operations.

### Prior Art

For the purposes of measuring the distance to objects by optical means, a measurement principle also referred to as LIDAR is known, amongst others, in which an optical signal whose frequency changes in time is emitted to the relevant object and evaluated after back-reflection has taken place at the object.

FIG. 10a shows, merely in a schematic illustration, a basic set up, known per se, in which a signal 1111 with a time-varying frequency (also referred to as “chirp”), emitted by a light source 1110, is split into two partial signals, this split being implemented, for example, by way of a partly transmissive mirror, which is not illustrated here. The two partial signals are coupled by way of a signal coupler 1150 and superposed at a detector 1160, with the first partial signal, as a reference signal 1122, reaching the signal coupler 1150 and the detector 1160 without a reflection at the object denoted by “1140”. By contrast, the second partial signal incident at the signal coupler 1150 or at the detector 1160, as a measurement signal 1121, propagates to the object 1140 via an optical circulator 1120 and a scanner 1130, is reflected back by said object and consequently arrives at the signal coupler 1150 and the detector 1160 with a time delay in comparison with the reference signal 1122 and a correspondingly altered frequency.

An evaluation device (not illustrated) is used to evaluate the detector signal supplied by the detector 1160 relative to the measuring apparatus or the light source 1110, with the difference frequency 1131 between the measurement signal 1121 and reference signal 1122, said difference frequency being captured at a certain time and illustrated in the diagram in FIG. 10b, being characteristic for the distance to the object 1140 from the measuring apparatus or the light source 1110. According to FIG. 10b, the time-dependent frequency curve of the signal 1111 emitted by the light source 1110 can also be designed so that there are two phases in which the time derivatives of the frequency generated by the light source 1110 are opposite to one another; this is to obtain additional information in respect of the relative speed between the object 1140 and the measuring apparatus or the light source 1110.

In practice, there is a need to realize a distance measurement that is as accurate and reliable as possible, even in the case of objects (possibly even moving objects) that are situated at relatively large distances, which could be vehicles in traffic, for example. In view of an apparatus for ascertainment of a distance which is as reliable as possible and which has the longest possible service life, it is further desirable to avoid or minimize the use of moving components such as scanning or deflection mirrors when scanning the respective object.

With regard to the prior art, reference is made purely by way of example to US 2016/0299228 A1.

### SUMMARY OF THE INVENTION

Against the aforementioned background, it is an object of the present invention to provide an apparatus for ascertainment of a distance to an object, which facilitates a distance measurement that is as accurate and reliable as possible, even for an object situated at a comparatively large distance (e.g., of several 100 m).

An apparatus according to the invention for ascertainment of a distance to an object comprises:
a light source for emitting an optical signal with a time-varying frequency;
an evaluation device for ascertaining a distance to the object on the basis of a measurement signal that arose from the optical signal and was reflected at the object and on the basis of a reference signal that was not reflected at the object; and
a dispersive element which brings about a frequency-selective angle distribution of the measurement signal, wherein partial signals generated hereby are steered to the object at mutually different angles.

In particular, the invention is based on the concept of realizing a scanning of an object in an apparatus for ascertaining the distance to the object when proceeding from the principle described on the basis of FIGS. 10a-10b by virtue of an angle distribution and, optionally, a spatial distribution of the different frequencies contained in the optical signal emitted by a light source being brought about in the signal path upstream of the object by way of a dispersive element, with these frequencies (or the partial beams having the respective frequencies) being steered—possibly adapted by way of an optional optical system as still described below—onto the object at different tilt or with different angles.

As a result, this effectively obtains scanning of the object without movable components such as scanning or deflection mirrors being required to this end. As a consequence, problems typically linked to the use of such movable components, in particular risks of outage and restrictions in the reliability and the service life of the apparatus accompanied by this, are also avoided. At the same time, a particularly compact structure is facilitated.

In embodiments, the dispersive element and the light source have a fixed spatial relationship with respect to one another. This feature expresses, in particular, that the realization of a scanning of the object according to the invention can be implemented even without a movement of the dispersive element itself relative to the light source.

According to one embodiment, a collimating optical element is arranged upstream of the dispersive element in relation to the signal path. If required, such an optional collimating optical element can ensure a beam path that is as collimated as possible at the point of incidence on the dispersive element.

According to one embodiment, an optical system for adapting the respective angles at which the partial signals are steered to the object is provided between the dispersive element and the object.

According to one embodiment, the optical system has a first lens and a second lens. Here, the dispersive element, in particular, can be arranged in a first focal plane of the first lens. According to one embodiment, a field plane of this optical system further corresponds to a first focal plane of the second lens.

In the structure described above, the mutually different angles of the partial signals generated by means of the dispersive element by way of a frequency-selective angle division of the measurement signal are transferred to different locations of a field plane by the first lens, which different locations are then, in turn, converted into an angle distribution by way of the second lens. Here, the partial beams corresponding to the different frequencies occur at different times (i.e., the different locations provided in a field plane by way of the dispersive element shine at different times).

In this configuration, too, the desired scanning of the object is consequently already achieved without requiring movable components such as scanning or deflection mirrors by virtue of the fact that different field points (corresponding to the frequency-selective spatial distribution provided by the dispersive element and the first lens) light up sequentially in time in accordance with the time variation of the frequency of the optical signal emitted by the light source, with this local variation being converted, in turn, into an angle distribution by the second lens of the optical system.

Objects measured in respect of their distance from the apparatus according to the invention within the scope of the invention can be, in a purely exemplary manner (and without the invention being restricted thereto), robot components such as robot arms or else objects that are relevant in road traffic or in the automotive sector (e.g. other vehicles). In addition to ascertaining the distance, the speed, for example, can also be ascertained (as known per se from US 2016/0299228 A1, for example).

According to one embodiment, the dispersive element has an AWG (=“array waveguide grating”). The use of such an AWG is particularly advantageous to the extent that a (wafer-) integrated and hence particularly compact structure is facilitated. In particular, the AWG can have at least 120 channels, in particular at least 240 channels. With a correspondingly large number of channels, it is possible to further increase the dispersion of the dispersive element and hence the speed of scanning.

However, the invention is not restricted to the realization of the frequency-selective spatial division by way of an AWG. In further embodiments, use can also be made of a different dispersive element bringing about the frequency-selective spatial division, for example a prism, a diffraction grating or Bragg grating or a spatial light modulator (e.g., an acoustic or electro-optic modulator).

According to one embodiment, the apparatus has an array of periodic structures that extend in two mutually perpendicular spatial directions. Here, in particular, a period length of these periodic structures can be in the range from 50 μm to 150 μm, in particular in the range from 80 μm to 120 μm.

Using such a two-dimensional configuration, two-dimensional scanning (i.e., scanning in the x-direction and in the y-direction) of the object can also be performed without the requirement of movable components such as scanning or deflection mirrors, with the consequence that, overall, it is possible to obtain high scan rates with, at the same time, a great reliability and a compact structure.

According to one embodiment, the apparatus has at least one component, by means of which the respective angle at which a partial signal is steered from the dispersive element to the object is variable. In embodiments of the invention, this component can be spatially separate from the dispersive element. Moreover, the relevant component could be movable.

According to one embodiment, the movable component has a deflection mirror which is arranged between the dispersive element and the object and which is tiltable about at least one tilt axis.

According to one embodiment, the movable component has a lens which is arranged between the dispersive element and the object and which is displaceable transversely to the propagation direction of the respective partial signal.

According to one embodiment, the dispersive element is displaceable transversely to the propagation direction of the respective partial signal for the purposes of varying the respective angle at which a partial signal is steered from the dispersive element to the object.

According to one embodiment, the apparatus has at least an optical modulator, in particular an electro-optic modulator or an acousto-optic modulator, downstream of the dispersive element in the light propagation direction. Such an optical modulator can bring about an additional, minor angle deflection of the respective optical signal or beam emanating from the dispersive element and consequently likewise bring about an increase in the resolution.

According to one embodiment, the time profile of the frequency of the optical signal emitted by the light source has an alternating sequence of, firstly, frequency jumps implemented for scanning the object and, secondly, partial intervals provided for ascertaining a distance to and/or speed of the object.

According to one embodiment, two sections with a different time dependence of the frequency are provided in each of the partial intervals provided for ascertaining a distance to and/or speed of the object.

Here, respectively one of these sections can be a section with a time-constant frequency. In further embodiments, these sections may each have opposite time derivatives of the frequency with respect to one another.

Further configurations of the invention can be gathered from the description and the dependent claims.

The invention is explained in greater detail below on the basis of embodiments illustrated in the accompanying figures.

### BRIEF DESCRIPTION OF THE DRAWINGS

Further features and advantages of the invention will become apparent from the following description of exemplary embodiments with reference to the drawings, in which:

FIG. 1 shows a schematic illustration for explaining the structure of an apparatus according to the invention in a first embodiment;

FIG. 2 shows a schematic illustration for explaining the structure of an apparatus according to the invention in a further embodiment;

FIGS. 3a-3c show schematic illustrations for further explanations in relation to the structure and functionality of an apparatus according to the invention in a further embodiment;

FIGS. 4a-4b show schematic illustrations for explaining possible embodiments of the invention;

FIGS. 5a-5c show schematic illustrations of further embodiments of the invention;

FIGS. 6a-6e, 7a-7c, 8a-8c, 9a-9b show schematic illustrations of further embodiments of the invention; and

FIGS. 10a-10b show schematic illustrations for explaining structure and functionality of a conventional apparatus for ascertainment of a distance.

### DETAILED DESCRIPTION OF EMBODIMENTS

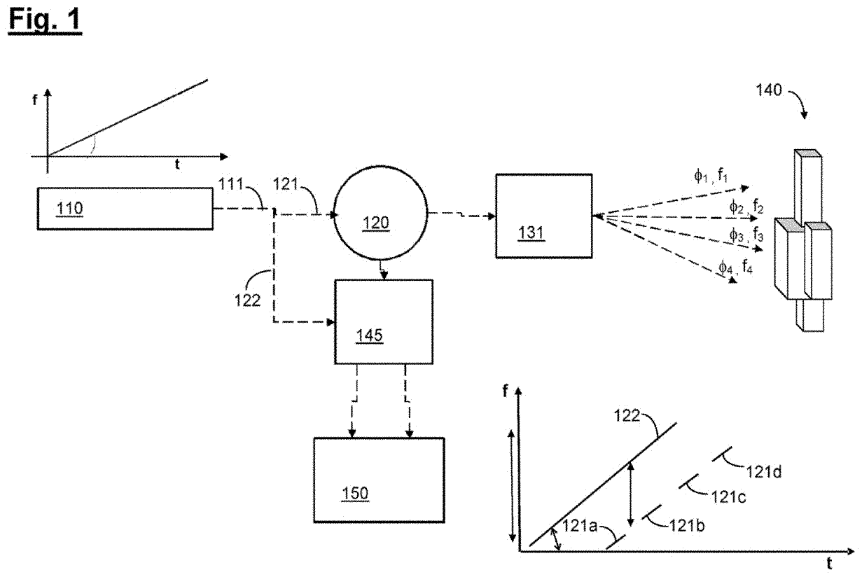

Below, structure and functionality of an embodiment of an apparatus according to the invention are described with reference to the schematic illustration of FIG. 1.

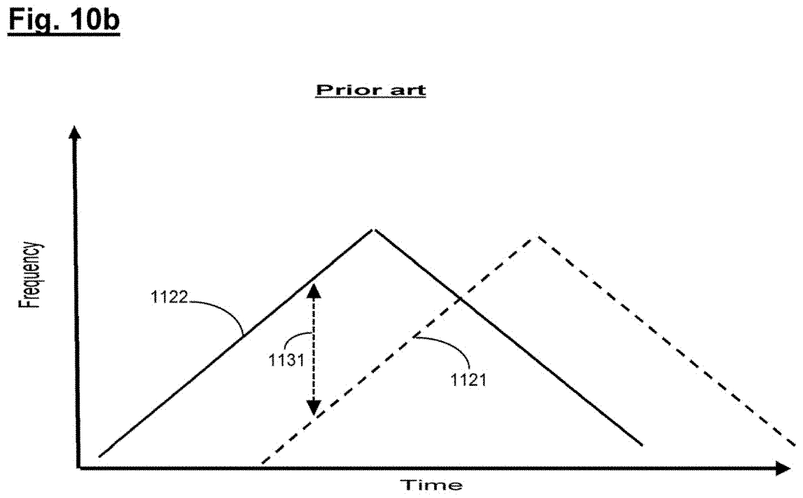

Initially proceeding from the conventional concept already described on the basis of FIGS. 10a-10b, an apparatus according to the invention comprises, as per FIG. 1, a light source 110 for emitting an optical signal 111 with a time-varying frequency (“chirp”). Purely by way of example, the light source 110 can have a (central) wavelength of 1550 nm±100 nm. Further wavelengths or bandwidths (e.g., 910 nm±50 nm) are likewise possible. According to the diagram plotted in the upper left part of FIG. 1, the optical signal 111 has a frequency profile with a linear time dependence in this embodiment. Sections each with an opposing time derivative of the frequency can also be used in embodiments of the invention, in a manner analogous to FIG. 10b.

In a manner likewise analogous to the conventional concept of FIGS. 10a-10b, the signal 111 emitted by the light source 110 is divided as per FIG. 1 by way of, e.g., a partly transmissive mirror, which is not illustrated here. Of these partial signals, a partial signal also referred to as “measurement signal” 121 below is steered, as described below, via an optical circulator 120 to an object 140, which should be measured in respect of its distance from the apparatus, whereas the other of the two partial signals is used as a reference signal 122 for the further evaluation, as described below.

As per FIG. 1, a beam (corresponding to the measurement signal 121), which has different frequencies f₁, f₂, f₃, f₄, . . . at different times, impinges on a dispersive element 131, from which different frequencies (i.e., partial beams having the respective frequencies) are deflected in mutually different directions (correspondingly mutually different angles ϕ₁, ϕ₂, ϕ₃, ϕ₄, . . . ) toward the object 140. This effectively obtains scanning of the object 140 without the requirement of moving components such as scanning or deflection mirrors.

As per FIG. 1, the partial signals 121a, 121b, 121c, 121d, . . . generated from the measurement signal 121 as described above are merged with the reference signal 122 in a coupler 145, with the consequence that the detector signals generated by a downstream detector arrangement 150 are each characteristic—as indicated in the lower right-hand part of FIG. 1—for the difference frequency between the frequency of the respective partial signal and the frequency of the reference signal. Here, in the diagram shown in the lower right-hand part of FIG. 1, the partial signals 121a, 121b, 121c and 121d respectively have the mid-frequency f₁, f₂, f₃ and f₄. As a result, the corresponding difference signal and consequently, in turn, the sought-after distance to the object 140 can be ascertained for each of the angles ϕ₁, ϕ₂, ϕ₃, ϕ₄, . . . .

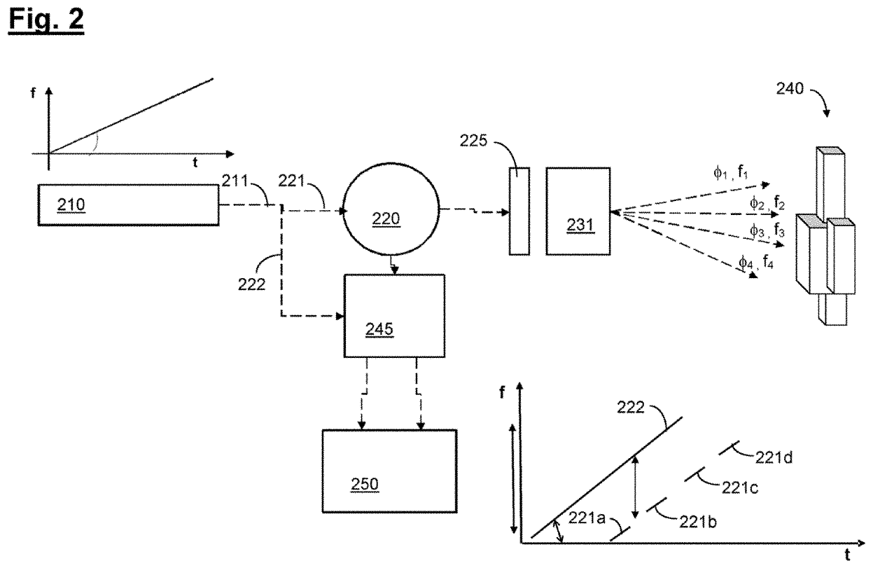

FIG. 2 shows a further embodiment, wherein components analogous or substantially functionally identical to FIG. 1 are designated by reference numerals increased by “100”. As per FIG. 2, a collimating optical element 225 is disposed upstream of the dispersive element 231 in relation to the beam path, by means of which collimating optical element it is possible, where necessary, to ensure a beam path that is as collimated as possible upon incidence on the dispersive element 231.

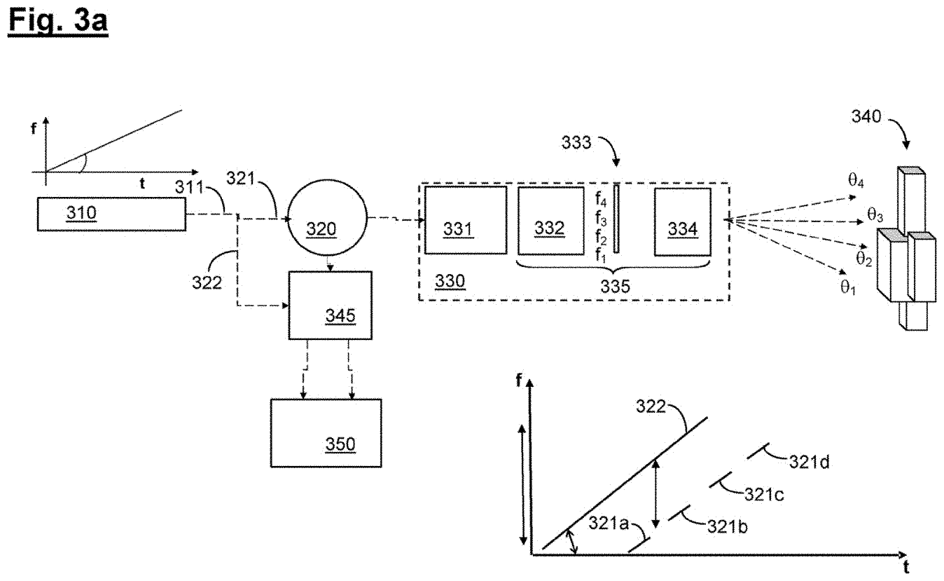

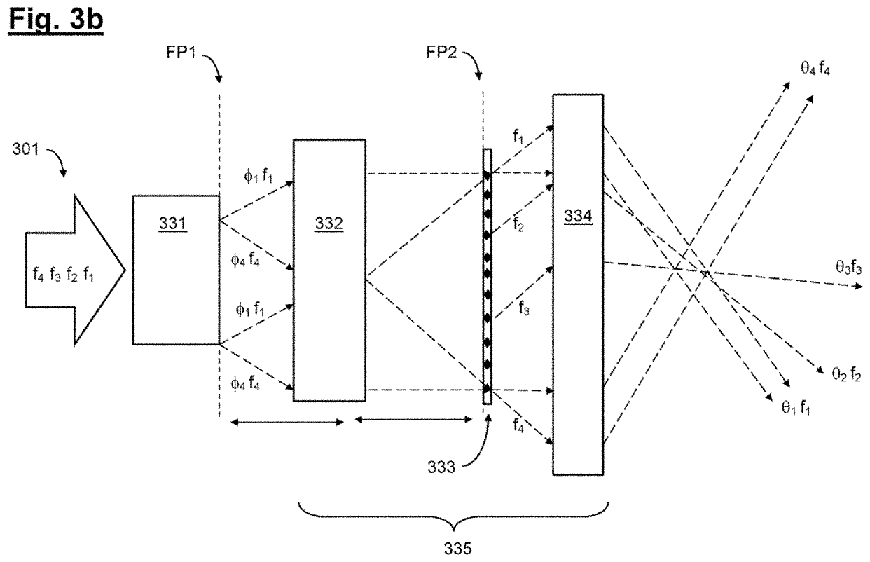

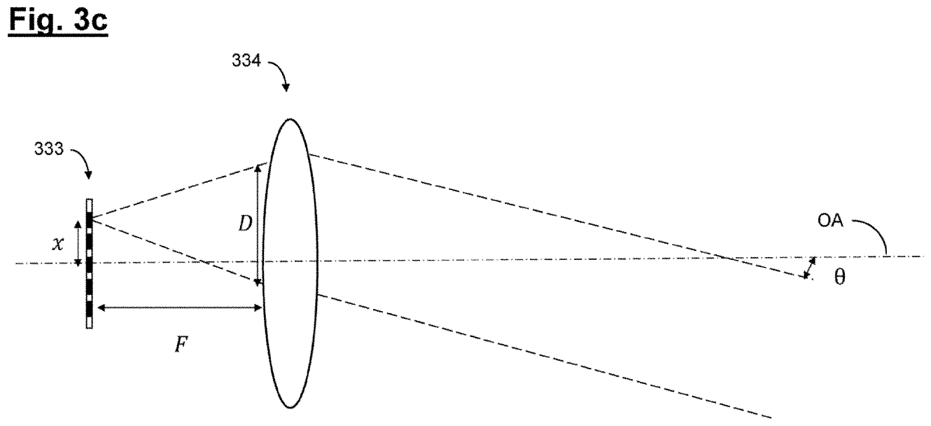

FIG. 3a shows a further embodiment, wherein components analogous or substantially functionally identical to FIG. 1 are designated by reference numerals increased by “200”.

As per FIG. 3a, an optical system 335 is provided between the dispersive element 331 and the object 340. As described below, this optical system 335 allows an adaptation of the respective angles at which the partial signals generated by frequency-selective spatial division of the measurement signal 321 are steered towards the object 340.

As per FIGS. 3a-3b, the optical system 335 has a first lens (or lens group) 332 and a second lens (or lens group) 334 (in a “4f-setup”). Here, the dispersive element 331 as per FIG. 3b is disposed in a first focal plane FP1 of the first lens 332. Moreover, a field plane 333 of the optical system 335 corresponds to a first focal plane FP2 of the second lens 334. As per FIG. 3a, the dispersive element 331 and the optical system 335 together form a scanning unit 330.

As per FIG. 3b, a beam 301 (corresponding to the measurement signal 321), which has different frequencies f₁, f₂, f₃, f₄, . . . , impinges on the dispersive element 331, from which different frequencies (i.e., partial beams having the respective frequencies) are deflected in mutually different directions (correspondingly mutually different angles ϕ₁, ϕ₂, ϕ₃, ϕ₄, . . . ). The dispersive element 331 is situated in the first focal plane FP1 of the first lens 332, which generates a field in the field plane 333. The partial beams respectively having different frequencies f₁, f₂, f₃, f₄, . . . are focused onto different locations in the field plane 333 in the process.

Once again, the field plane 333 corresponds to a first focal plane FP2 of the second lens 334. The partial beams emanating from different locations in the field plane 333 are once again deflected in mutually different directions (corresponding to mutually different angles θ₁, θ₂, θ₃, θ₄, . . . ) by the second lens 334, said different angles once again corresponding to different frequencies f₁, f₂, f₃, f₄, . . . . Since these partial beams corresponding to respectively different frequencies f₁, f₂, f₃, f₄, . . . occur at different times (i.e., the different locations in the field plane 333 shine at different times), this in turn effectively achieves scanning of the object 340 from FIG. 3a.

FIG. 3c shows a further schematic illustration for explaining the principle underlying the embodiment of FIGS. 3a-3b. Accordingly, the different locations provided in the field plane 333 by way of the dispersive element 331 are situated in the first focal plane of the (achromatic) second lens 334 (i.e., at the distance of the focal length F of the second lens) and light up in sequence in a manner corresponding to the temporal frequency profile (i.e., at different successive times). In the process, a beam emanating from a location in the field plane 333 at a distance “X” from the optical system axis OA receives a tilt θ with respect to the optical system axis OA, which is given by θ=x/F. Here, as per FIG. 3, the beam dimension D is determined by the numerical aperture NA and the focal length F according to D=2·F·NA, i.e., F=D/(2·NA) applies.

Exemplary quantitative values for the beam dimension D could lie in the range of D=(10-15) mm for the aforementioned applications in road traffic or the automotive sector. If a typical value of the numerical aperture NA of 0.12 is assumed, suitable values for the focal length F are consequently of the order of approximately 50 mm, and so a comparatively compact system can be realized.

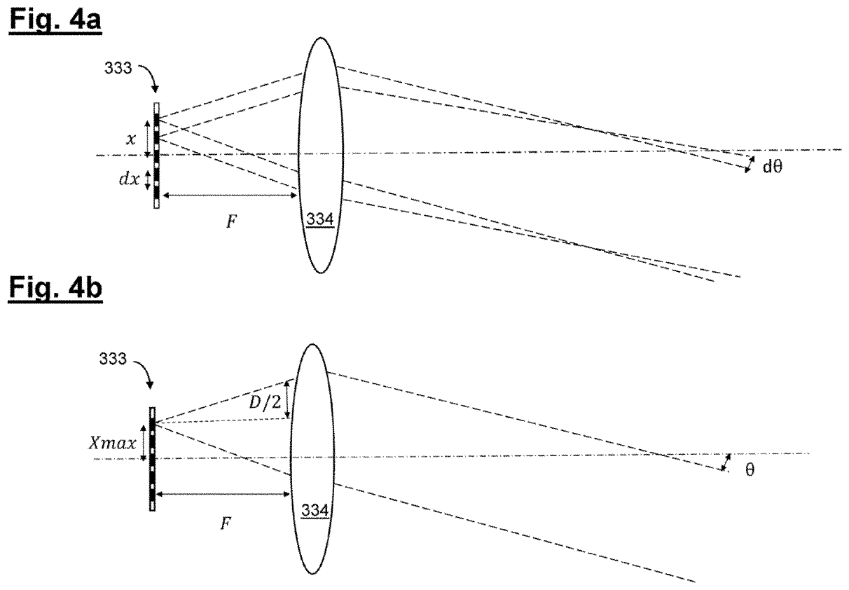

In respect of the angular resolution realizable with the apparatus according to the invention, typical values to be demanded for the aforementioned applications in road traffic or the automotive sector can be 2 mrad, for example. With reference to FIG. 4a, this yields a period length in the field plane 333 (i.e., a spacing of adjacent channels provided by the dispersive element 331) of approximately dx=0.1 mm in the case of the aforementioned value of the focal length of F=50 mm. If, with reference to FIG. 4b, the free aperture of the lens 334 is restricted to CA=70 mm, then the maximum distance xₘₐₓ from the optical system axis OA admissible for a shining location in the field plane 333 still imaged by the lens 334 is consequently Xₘₐₓ=(CA−D)/2=(70−12)/2 mm=29 mm in the aforementioned example. NA_{scan}=Xₘₐₓ/F=(29/50) mm=0.58 arises for the numerical aperture NA_{scan}. Nₘₐₓ=2·Xₘₐₓ·/dx=580 arises for the number of channels (or shining “sources”) in the field plane 333.

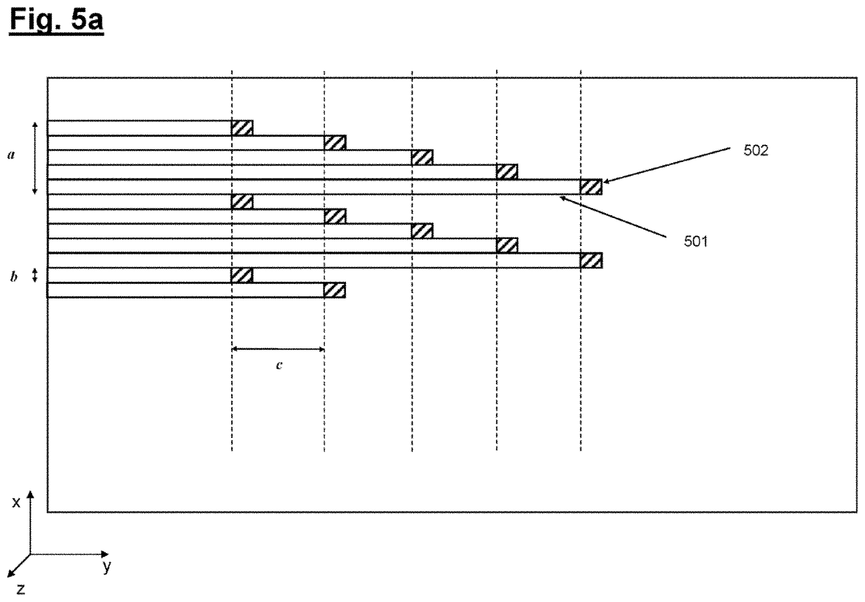

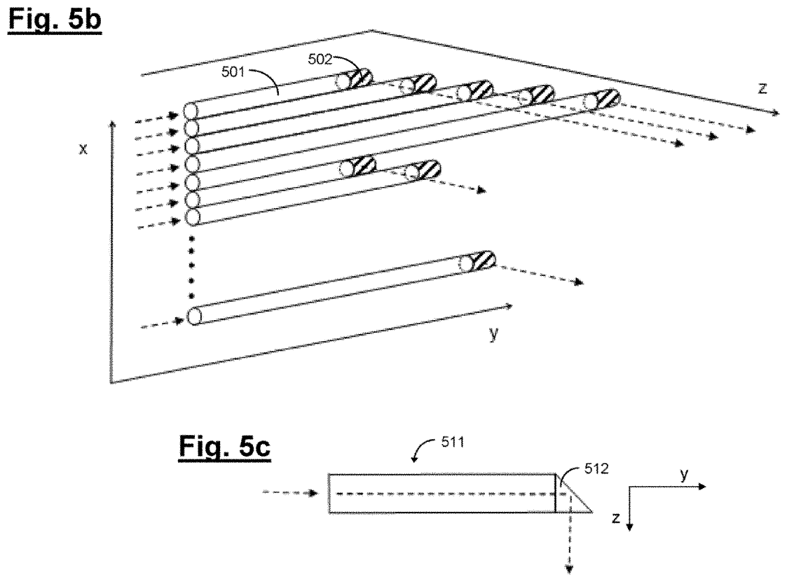

The value of the period length in the field plane 333 (i.e., of the spacing of adjacent channels provided by the dispersive element 331) of approximately 0.1 mm=100 μm chosen in the aforementioned example also facilitates a two-dimensional configuration in accordance with a two-dimensional array of two periodic structures extending in mutually perpendicular spatial directions, as illustrated schematically in FIGS. 5a-5b (with FIG. 5b showing a perspective view for a better understanding). The realization of the two-dimensional configuration or of the array corresponding to a two-dimensional array is implemented as per FIGS. 5a-5b by way of waveguides 501, the respective end section of which is provided with a diffractive structure 502 serving for output coupling purposes. In a further representation, merely indicated schematically in FIG. 5c, the output coupling from the respective end section of the waveguides (denoted by “511” in FIG. 5c) can also be implemented by way of a prism 512 in each case.

On account of the two-dimensional array of periodic structures extending in two mutually perpendicular spatial directions, a periodic sequence of “shining sources” (with the period length of c=100 μm) as per FIGS. 5a-5b is not only realized in the y-direction; instead, such a periodic sequence of “shining sources” with the periodic length of a=100 μm is also realized in the x-direction. Here, use can be made of the circumstances that the dimension b of the channels itself is typically only approximately b=10 μm in the case of an AWG with an Si/SiO₂ platform, with the consequence that a two-dimensional offset arrangement as visible in FIGS. 5a-5b is possible. Smaller channel dimensions are also possible for other platforms (e.g., an Si platform), and so an even greater scanning or angle range can be realized in a two-dimensional scanner in the case of the aforementioned period length of a=100 μm.

The arrangement, explained above on the basis of FIGS. 5a-5c, in the form of the two-dimensional array can be arranged in such a way, for example, that, with reference to FIG. 3b again, the waveguides 501 and 511 each emanate from the field plane 333 of the optical system 335 and, for example, there is a 90° deflection of the optical beam path or corresponding folding of the optical system axis toward the second lens (or lens group) 334 at the end of each waveguide 501 and 511.

Using the two-dimensional configuration described on the basis of FIGS. 5a-5c, two-dimensional scanning (i.e., scanning in the x-direction and in the y-direction) of the object can also be performed without the requirement of movable components such as scanning or deflection mirrors, with the consequence that, overall, it is possible to obtain high scan rates with, at the same time, a great reliability and a compact structure.

However, the invention is advantageous even in the case of an only one-dimensional configuration of the channels provided by the dispersive element (as described with reference to FIG. 2 to FIG. 4). In addition to applications in which a one-dimensional scanning of the object (e.g., in the x-direction only) is sufficient in any case, this also applies to applications with two-dimensional scanning of the object (i.e., in the x-direction and in the y-direction) since, for the scanning in the spatial direction not extending along the periodic sequence of channels (the y-direction in this example), a comparatively slow-moving scanning mirror is also sufficient for scanning in this spatial direction in this case.

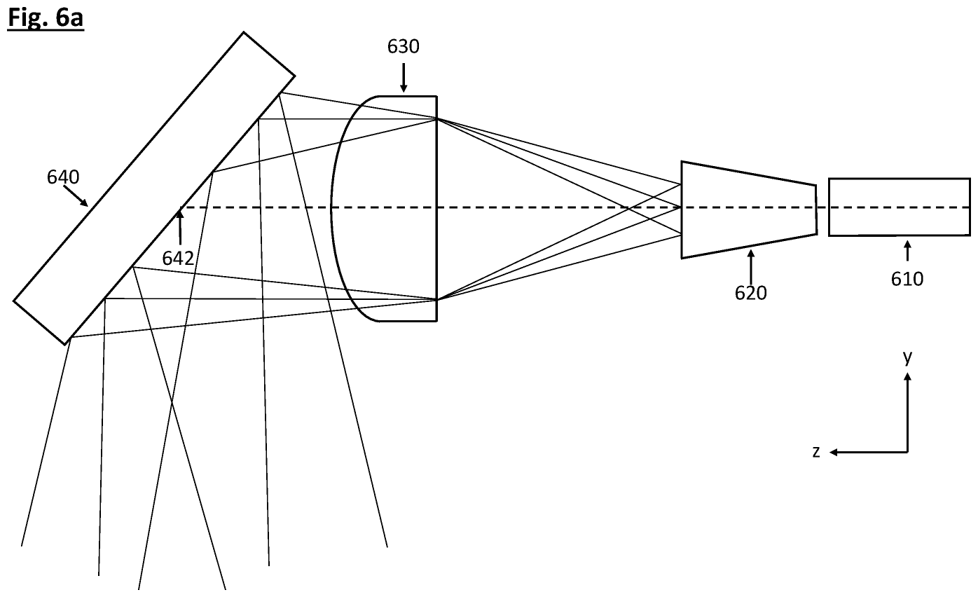

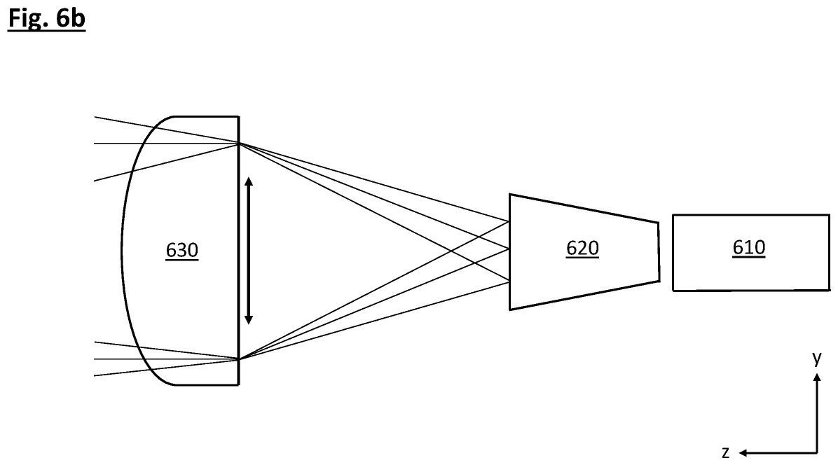

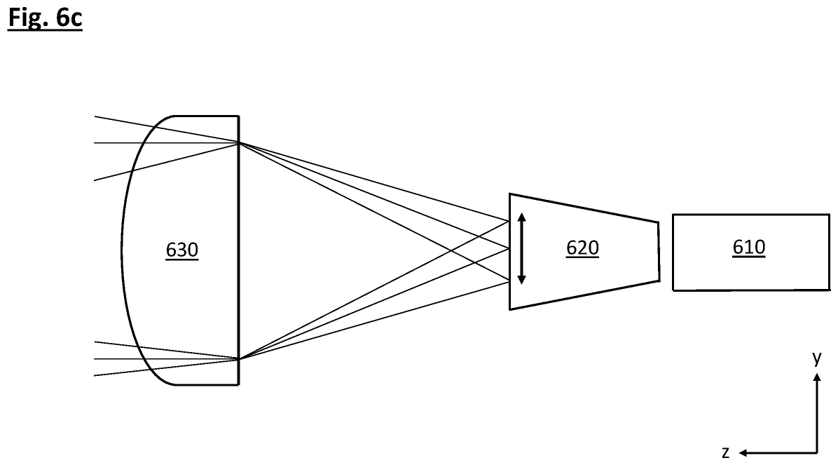

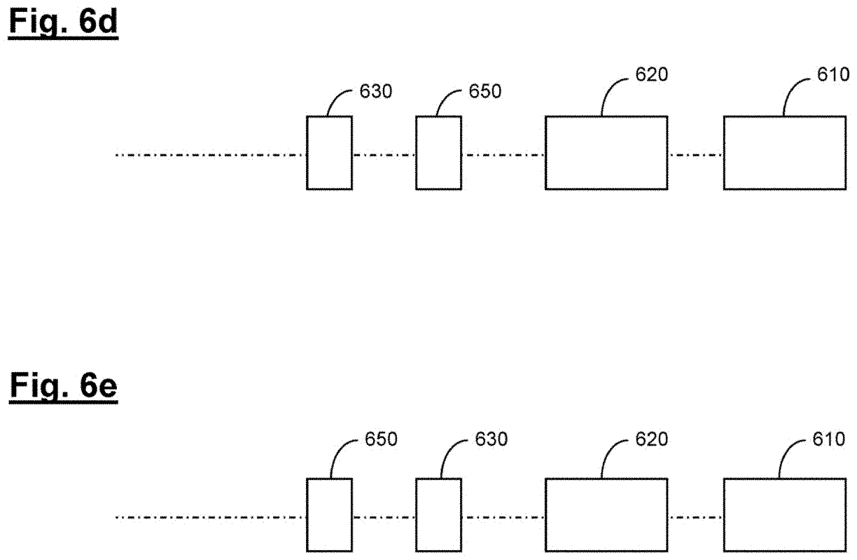

According to a further aspect of the present invention, described below with reference to FIGS. 6a-6e, the fact that the angle resolutions obtainable with a dispersive element or AWG used according to the invention are limited is taken into account. In a quantitative calculation example for explaining this limited angle resolution, a frequency change of 2.5 THz arises for an exemplary work wavelength of 1550 nm and a tuning range of the light source of 20 nm. On the basis of typical band gaps of (10-100) GHz obtainable with an AWG in telecommunications, a total of 25-250 separable channels arises, with this number being significantly too low in view of the number of pixels required for generating an image, which is of the order of 10⁵.

In order to overcome the above-described problem, the invention now contains the further concept of obtaining an increase in the resolution by providing an additional angle variation of the partial signals steered from the dispersive element or AWG to the object (and hence of effectively once again “scanning” the distance between separate pixels generated via the dispersive element or AWG).

In embodiments of the invention, the above-described angle variation can be realized in micromechanical fashion by virtue of a movable component being inserted between the dispersive element and the object, by means of which movable component the respective angle of the partial signals steered to the object is variable.

FIG. 6a shows a deflection mirror 640 as a possible realization of said movable component in a purely schematic and greatly simplified illustration, said deflection mirror being tiltable by way of at least one flexure bearing about at least one tilt axis (which extends perpendicular to the plane of the drawing in FIG. 6a and which is denoted by “642”). In FIG. 6a, “610” denotes the tunable light source, “620” denotes the dispersive element according to the invention and “630” denotes a lens or a collimator objective lens represented thereby.

Although the embodiment as per FIG. 6a implies accepting the use of a mechanically movable component—unwanted per se—it makes use of the fact that the deflection angles to be provided by this component (which, as explained above, should merely facilitate “scanning” between successive pixels generated by the dispersive element) are comparatively small with typical values ranging from 1°-2° (corresponding to tilt angles ranging from 0.5°-1°).

Expressed differently, what is achieved, inter alia, according to the invention by the combination of a dispersive element or AWG with an above-described movable mechanical element such as, e.g., a deflection mirror, which is used to increase the resolution, is that, firstly, the ultimately obtained resolution is increased beyond the number of channels which are spectrally separable by means of the dispersive element but, secondly, only comparatively small micromechanical movements are required to this end (such as, e.g., the aforementioned tilt angles of the order of 1°). The circumstances specified last are important here to the extent that significantly larger tilt angles are no longer realizable in practice inter alia on account of the observable torsion limits of micromechanically actuated materials.

In respect of the above-described increase in the resolution by way of a mechanically moving component, the invention is not restricted to the use of a deflection mirror 640 as per FIG. 6a. Thus, in a further embodiment with a comparable effect, also as per FIG. 6b, there can be a displacement of a lens 630, e.g., of a collimator objective lens, laterally or transversely to the propagation direction of the respective partial signals. According to FIG. 6c, an AWG itself, used as a dispersive element 620, can also be displaced in the lateral direction or transversely to the propagation direction of the respective partial signals in further embodiments.

To increase the resolution in yet further embodiments, use can also be made of a modulator 650 (in particular an electro-optic or an acousto-optic modulator) instead of a mechanically movable element for bringing about an additional minor angle deflection of the beam (emanating from the lens 630 or entering the lens 630) with a comparatively high resolution, as illustrated merely schematically in FIGS. 6d-6e and as a development of the embodiments of FIGS. 6a-6c. By way of example, such an optical modulator 650 can be used instead of the deflection mirror 640 in FIG. 6a. Moreover, on account of the small beam deflection, such an optical modulator 650 can be alternatively arranged upstream of the lens 630 (cf. FIG. 6d) or else downstream of the lens 630 (cf. FIG. 6e) in relation to the light propagation direction.

The invention further also contains the concept of choosing the respective time dependence of the frequency of the signal emitted by the light source in such a way that not only is scanning of the object realized in conjunction with the dispersive element but that, moreover, a separation of this function from the actual measurement task (specifically the distance and optional speed determination) is also achieved. To this end, the time profile of the frequency of the signal emitted by the light source can contain, firstly, comparatively quickly occurring jumps in the frequency (with a relatively large frequency change of the order of 30 GHz) for the purposes of quickly scanning the surface of the object in conjunction with the dispersive element and, secondly, also sections in the time profile of the frequency that are separate from these frequency jumps, in which the difference frequency or beat frequency signals contained in the measurement are used to determine the distance and possibly the speed (with this determination of distance and speed then being performable with a comparatively simple electronic setup as a consequence of the possible restriction of the beat frequency to values of the order of 1 GHz).

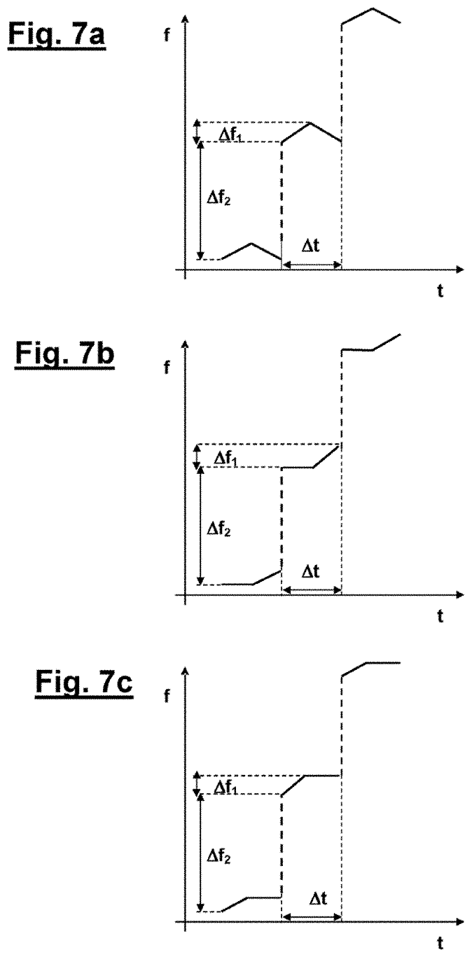

In respect of the sections in the time profile of the frequency of the signal emitted by the light source mentioned last, which are used for the actual measurement, there can once again be regions with mutually different time dependence of the frequency, as illustrated in the schematic illustrations of FIGS. 7a-7c, for the purposes of realizing a distance and speed determination.

Specifically, each time period Δt as per FIGS. 7b-7c, which is used by the respective next frequency jump as a “measurement interval”, comprises a partial interval with a frequency constant in time and a further partial interval with a frequency linearly increasing in time. Here, the entire frequency change in the partial interval with frequency linearly increasing in time is denoted by Δf₁ in FIGS. 7b-7c, and the frequency change between the frequencies present at the start of successive time periods Δt is denoted by Δf₂.

By contrast, according to FIG. 7a, each time period Δt, which is used by the respective next frequency jump as a “measurement interval”, comprises a partial interval with a frequency linearly increasing in time and a further partial interval with a frequency linearly decreasing in time. The entire frequency change in the partial intervals with frequency linearly increasing or decreasing in time is denoted by Δf₁ in FIG. 7a, and the frequency change between the frequencies present at the start of successive time periods Δt is denoted by Δf₂. The use of these partial intervals for determining distance and speed is based on the deliberation that, as a consequence of the aforementioned significant size differences between the frequency jumps used for the scanning process and the frequency changes occurring in the respective measurement intervals, a change in angle brought about, in principle, by the dispersive element even during the measurement intervals is negligible.

In the examples of FIG. 7b and FIG. 7c, the distance of the object, not yet corrected in view of the Doppler effect, can be calculated in respectively one partial interval in a manner known per se on the basis of the signal with the frequency value that varies linearly in time, whereas the speed of the object can be ascertained in the same partial interval on the basis of the signal with the frequency value constant over time. As a result, the signal not yet corrected in view of the Doppler effect can be transformed accordingly on the basis of the information obtained, in order to ascertain the distance to the object, which has been corrected in relation to the Doppler effect.

In the example of FIG. 7a, a Doppler effect-compensated distance ascertainment can be formed in each case in a partial interval in a manner known per se and analogous to FIGS. 10a-10b.

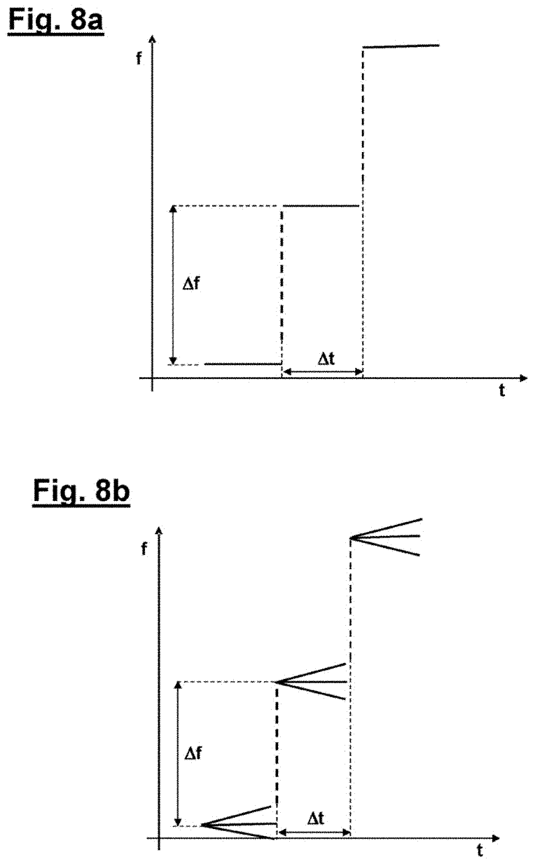

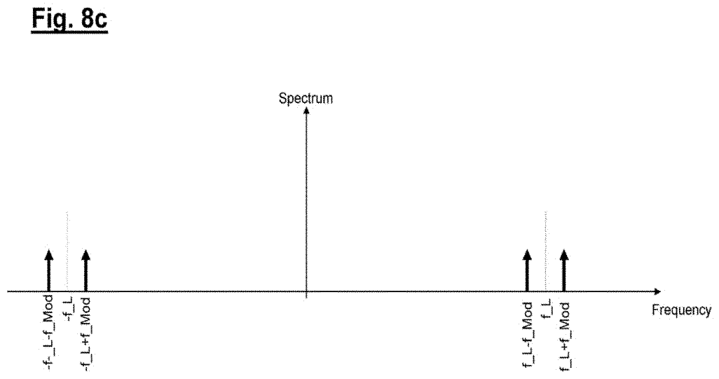

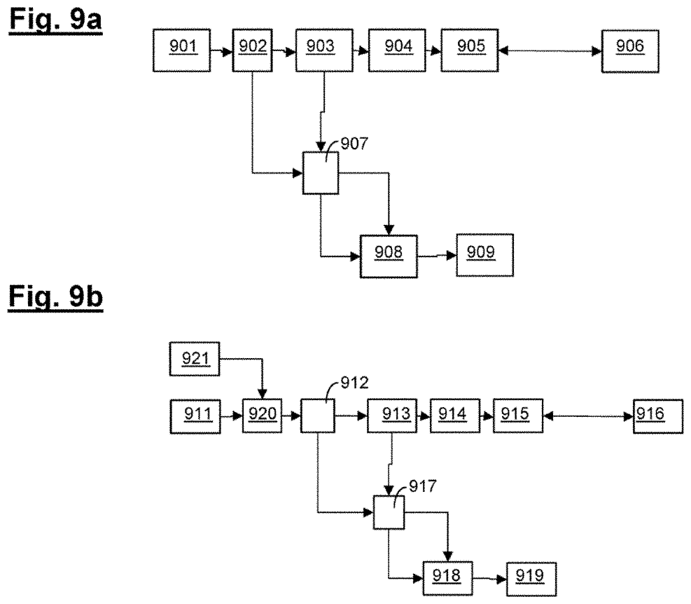

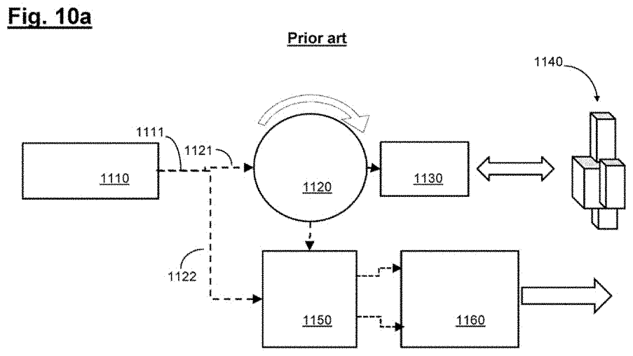

The concept of separating the two functions of, firstly, “scanning the object” and, secondly, “performing the actual distance and optional speed determination”, described above on the basis of FIGS. 7b-7c, is also realizable in further embodiments of the invention in conjunction with a distance measurement on the basis of the so-called “sideband modulation” principle. To explain and illustrate the concept of sideband modulation, reference is made to the schematic illustrations in FIGS. 8a-8c and 9a9b.

Here, FIG. 9b shows purely schematically a possible structure for realizing the sideband modulation in accordance with the invention, i.e., in combination with a dispersive element used for realizing the scanning process.

In a schematic illustration analogous thereto, FIG. 9a shows a structure in which the principal described on the basis of FIG. 1 of the present application (i.e., in which the frequency of the optical signal generated by the light source itself is tuned) is realized.

To this extent, the structure of FIG. 9a corresponds, in principle, to that of FIG. 1. Here, an optical signal generated by the light source 901 is split into two partial signals by way of a beam splitter or splitter 2, one partial signal of which is steered as a measurement signal via an optical circulator 903, a dispersive element 904 (e.g., configured as an AWG) and a dispersive scanning device 905 to the object 906 to be measured in respect of its distance and, on its return, reaches a signal coupler 907 via the optical circulator. The second of the two partial signals provided by the beam splitter 902, which is not reflected in the object 906, directly reaches the signal coupler 907 as a reference signal. The partial signals coupled by the signal coupler 907 are overlaid on one another at a balanced detector 908 and evaluated in an evaluation device 909 for the purposes of ascertaining the distance to the object 906.

As already explained above, there is a time variation in the frequency of the signal emitted by the light source 901 in the structure of FIG. 9a, wherein, in particular, the time dependencies of the frequency described above on the basis of FIG. 7a, 7b or 7c can be set in order to realize the aforementioned separation of the function of scanning the object in conjunction with the dispersive element on the one hand from the actual measurement task (i.e., the distance and optional speed determination of the object 906) on the other hand.

Said separation between the functions of, firstly, “scanning the object” and, secondly, “distance and speed determination” can also be implemented by applying the concept of the sideband modulation as per FIG. 9b in conjunction with the use according to the invention of a dispersive element. Here, in FIG. 9b, components analogous or substantially functionally identical in comparison with FIG. 9a are designated by reference signs increased by “10”. The structure of FIG. 9b differs from that of FIG. 9a in that, in particular, the light source 911 serving to generate the optical signal is no longer itself frequency-tuned in time for the distance or the speed determination; instead, a modulation of this signal is brought about by way of a modulation unit 920 (which may be configured as an electro-optic modulator, for example). By contrast, according to FIG. 9b, a change in the frequency of the optical signal emitted by the light source 911 itself is only brought about for the purposes of scanning the object by virtue of, as indicated in FIG. 8a, this frequency being respectively increased by discrete steps Δf at time intervals Δt (in a manner analogous to FIGS. 7a-7c). In particular, the modulation unit 920 can be driven by a control unit 921 in such a way that a linear time dependence of the signal provided by the modulation unit 920 is set, the modulation by the modulation unit 920 always setting in whenever the frequency of the optical signal of the light source 911 was raised to a respectively new discrete frequency step as per FIG. 8b. The frequency of the optical signal generated by the light source 911 itself then jumps by discrete steps Δf as per FIGS. 8a-8b, as a result of which—in this respect analogously to the embodiments of FIGS. 7a-7c—the function of scanning the object is realized.

In the case of the “sideband modulation”, an intensity modulation within the meaning of multiplying the optical signal emitted by the light source 911 by a sine or cosine signal with a time-varying modulation frequency respectively within the relevant time intervals leads, in the frequency spectrum of the signal modulated by said modulation frequency at a corresponding distance to the (carrier) frequency (f_L) of the optical signal originally emitted by the light source, to the occurrence of two (“delta”) pulses with a frequency value increased or reduced by said modulation frequency (f_Mod) (i.e., with the frequency f_L+f_Mod or f_L−f_Mod), as indicated in FIG. 8c. Then, the time variation of said modulation frequency is accompanied with a “migration” of these pulses in the frequency spectrum, as indicated in FIG. 8b. In combination with the concept according to the invention of the scanning process realized by way of a dispersive optical element in conjunction with an increase in the frequency of the optical signal in discrete steps, as already described on the basis of FIG. 8a, this sideband modulation leads to the required information for ascertaining the speed or compensating the Doppler effect also being already contained at the same time in the ultimately obtained detector signal or the difference frequency between the measurement signal and reference signal.

Even though the invention has been described on the basis of specific embodiments, numerous variations and alternative embodiments will be apparent to the person skilled in the art, for example through combination and/or exchange of features of individual embodiments. Accordingly, it goes without saying for the person skilled in the art that such variations and alternative embodiments are concomitantly encompassed by the present invention, and the scope of the invention is restricted only within the meaning of the appended patent claims and the equivalents thereof.

1. An apparatus for ascertaining a distance to an object, wherein the apparatus comprises:
a light source configured to emit an optical signal having a time-varying frequency,
an evaluation device configured to ascertain a distance to the object based on
a measurement signal that originated from the optical signal and was reflected at the object and
a reference signal that was not reflected at the object,
a dispersive element configured to produce a frequency-selective angle distribution of the measurement signal, wherein the frequency-selective angle distribution comprises a plurality of partial signals that are steered to the object at mutually different angles.

2. The apparatus of claim 1, wherein the dispersive element and the light source have a fixed spatial relationship with respect to one another.

3. The apparatus of claim 1, comprising wherein a collimating optical element that is arranged upstream of the dispersive element in a signal path of the optical signal.

4. The apparatus of claim 1, comprising an optical system arranged between the dispersive element and the object and configured to adapt the different angles, at which the partial signals are steered to the object.

5. The apparatus of claim 4, wherein the optical system comprises a first lens element or a first group of lens elements, and a second lens element or a second group of lens elements.

6. The apparatus of claim 5, wherein the dispersive element is arranged in a front focal plane of the first lens or the first lens group.

7. The apparatus of claim 5, wherein the optical system has a field plane that is defined by a front focal plane of the second lens or the second lens group.

8. The apparatus of claim 1, wherein the dispersive element comprises an array waveguide grating (AWG).

9. The apparatus of claim 8, wherein the AWG has at least 120 channels.

10. The apparatus of claim 1, wherein the dispersive element comprises at least one of the group consisting of: a prism, a diffraction grating, a spatial light modulator such as an acoustic or electro-optic modulator.

11. The apparatus of claim 1, comprising an array of periodic structures that extend in two mutually perpendicular spatial directions.

12. The apparatus of claim 11, wherein the periodic structures have a period length that is in the range from 50 μm to 150 μm.

13. The apparatus of claim 1, comprising at least one component configured to vary an angle at which a partial signal is steered from the dispersive element to the object.

14. The apparatus of claim 13, wherein the component is spatially separated from the dispersive element.

15. The apparatus of claim 13, wherein the component is movably arranged.

16. The apparatus of claim 15, wherein the component comprises a deflection mirror that is arranged between the dispersive element and the object, and wherein the deflection mirror is configured to be tilted about at least one tilt axis.

17. The apparatus of claim 15, wherein the component comprises a lens that is arranged between the dispersive element and the object, and wherein the lens is configured to be displaced transversely to a propagation direction of the respective partial signal.

18. The apparatus of claim 1, wherein the dispersive element is configured to be displaced transversely to a propagation direction of the respective partial signal in order to vary an angle at which a partial signal is steered from the dispersive element to the object.

19. The apparatus of claim 1, comprising an optical modulator arranged downstream of the dispersive element in a light propagation direction.

20. The apparatus of claim 1, wherein a time profile of the frequency of the optical signal emitted by the light source has an alternating sequence of partial intervals, wherein the frequency jumps between adjacent partial intervals.

21. The apparatus of claim 20, wherein each partial intervals comprises two sections having a different time dependence of the frequency.

22. The apparatus of claim 21, wherein one of the two sections has a time-constant frequency.

23. The apparatus of claim 21, wherein the two sections have opposite time derivatives of the frequency.

24. An apparatus for ascertaining a distance to an object, wherein the apparatus comprises:
a light source configured to emit an optical signal having a time-varying frequency,
an evaluation device configured to ascertain a distance to the object based on
a measurement signal that originated from the optical signal and was reflected at the object and
a reference signal that was not reflected at the object,
a dispersive element configured to produce a frequency-selective angle distribution of the measurement signal, wherein the frequency-selective angle distribution comprises a plurality of partial signals that are steered to the object at mutually different angles,
an optical system arranged between the dispersive element and the object and having a front focal plane, wherein the dispersive element is arranged in the front focal plane of the optical system,
wherein
a time profile of the frequency of the optical signal emitted by the light source has an alternating sequence of partial intervals, wherein the frequency jumps between adjacent partial intervals.
